(19) United States
(12) Patent Application Publication
(10) Pub. No.: US 2025/0370141 A1
(43) Pub. Date: Dec. 4, 2025

(54) Method and Device for Improved Positioning of an Ego Vehicle Using a 3D Object Recognition Module

(71) Applicant: Robert Bosch GmbH, Stuttgart (DE)

(72) Inventors: Yakov Miron, Yakov (IL); Florian Faion, Staufen (DE); Dotan Di Castro, Haifa (IL)

(21) Appl. No.: 19/225,209

(22) Filed: Jun. 2, 2025

(30) Foreign Application Priority Data
Jun. 4, 2024 (DE) 10 2024 205 129.2

(51) Int. Cl. G01S 19/14; G06V 10/82; G06V 20/58

(52) U.S. Cl. CPC G01S 19/14; G06V 10/82; G06V 20/58

(57) ABSTRACT

A method for improved positioning of an ego vehicle that includes a localization system, a 3D object recognition module, and a position amalgamation module is disclosed. The method includes a) determining the position of the ego vehicle for the current time step with the localization system, b) determining a position of at least one adjacent vehicle in the vicinity of the ego vehicle with the 3D object recognition module, c) amalgamating the position of the ego vehicle determined in step a) with the position of the at least one adjacent vehicle determined in step b) to form a position amalgamation result with the position amalgamation module, and d) determining the position of the ego vehicle for the next time step with the localization system, taking into account the amalgamation result.

This application claims priority under 35 U.S.C. § 119 to application no. DE 10 2024 205 129.2, filed on Jun. 4, 2024 in Germany, the disclosure of which is incorporated herein by reference in its entirety.

### BACKGROUND

The present disclosure relates to a method and device for improved positioning of an ego vehicle using a 3D object recognition module. In addition, a control unit, a computer program and a machine-readable storage medium are disclosed. The disclosure can particularly be used in GNSS-based localization systems for autonomous or semi-autonomous driving.

Modern vehicles are typically equipped with GNSS-based localization systems for positioning. In addition, sensors may be on board to sense the surroundings such as radar, cameras, ultrasonic sensors, etc.

In order to improve the positioning accuracy, in some known approaches, several Inertial Measurement Units (IMUs) can be on board, which are typically arranged on the same rigid body so that measurements can be projected from one sensor to another, e.g. using rigid body simulation. In some other known approaches, geometrical knowledge about the surroundings can be used, for example, in the form of point clouds captured by lidar. These point clouds may in turn be used by another agent to predict its own position and pose. However, this requires high-bandwidth communication systems for information exchange, as these point clouds cannot be readily exchanged via conventional low-bandwidth communication systems.

Therefore, there is a desire to create a novel method for improved positioning that does not require rigid body simulation or a communication system for exchanging point cloud-relevant information.

### SUMMARY

This need is met by a method for improved positioning of an ego vehicle, wherein the ego vehicle comprises a localization system, a 3D object recognition module, and a position amalgamation module, and wherein the method comprises the steps of:
a) determining the position of the ego vehicle for the current time step with the localization system,
b) determining a position of at least one adjacent vehicle in the vicinity of the ego vehicle with the 3D object recognition module,
c) amalgamating the position of the ego vehicle determined in step a) with the position of the at least one adjacent vehicle determined in step b) to form a position amalgamation result with the position amalgamation module, and
d) determining the position of the ego vehicle for the next time step with the localization system, taking into account the amalgamation result.

The method described is particularly suitable for autonomous driving. Autonomous driving can be understood to mean the movement of vehicles that are largely autonomous, e.g., by way of a GNSS-based localization system and/or sensors for perception of the surroundings, such as radar, cameras, ultrasonic sensors. The vehicles may be motor vehicles, such as passenger cars, trucks or other commercial vehicles, robots or the like.

To perform the described method, the ego vehicle is provided with a localization system, a 3D object recognition module, and a position amalgamation module.

Unlike known localization systems, wherein the position of an ego vehicle for the next time step is predicted recursively based on real-time measurement data and the position of the ego vehicle determined in the current time step, the localization system described here can predict the position of the ego vehicle for the next time step based on real-time measurement data and a position amalgamation result, wherein the position amalgamation result can be determined by amalgamation of the position of the ego vehicle determined in the current time step with the position of at least one adjacent vehicle determined in the current time step using the position amalgamation module, and wherein the position of the at least one adjacent vehicle can be determined with the 3D object recognition module.

The adjacent vehicles described here are only those vehicles that are in the vicinity of the ego vehicle and their positions, which can be sensed using the 3D object recognition module located in the ego vehicle.

The localization system described here may in particular be a GNSS-based localization system capable of determining the position of the ego vehicle by receiving GNSS signals. GNSS is the abbreviation for Global Navigation Satellite Systems (GPS, GLONASS, Galileo, and Beidou). The real-time measurement data is in particular the measured GNSS signals in the field of view of the ego vehicle.

According to step a), the position of the ego vehicle for the current time step is determined with the localization system. The position of the ego vehicle may be determined from the currently measured data (i.e., real-time measurement data), such as the currently measured GNSS signals.

The 3D object recognition module described here is capable of sensing the position of at least one adjacent vehicle according to an approach known from the field of computer vision. Computer vision is a field within artificial intelligence (AI) that enables computers and system to obtain meaningful information from digital images, videos, and other visual inputs—and to take action or make recommendations based on that information.

For example, the 3D object recognition module is capable of detecting objects in the vicinity of the ego vehicle based on, for example, data measured by at least one sensor, wherein the at least one sensor is typically a camera or a lidar. Thus, the 3D object recognition module may detect not only an object in the vicinity of the ego vehicle, but also sense the position of the detected object and distinguish the type of object detected (e.g., whether it is a vehicle or a tree).

In particular, the 3D object recognition module may be a deep learning trained neural network implemented in the ego vehicle and capable of detecting and assigning objects to the corresponding category, as well as determining the position of the respective detected objects, for example, using a 3D bounding box.

According to step b), the position of at least one adjacent vehicle in the vicinity of the ego vehicle is determined with the 3D object recognition module. Depending on the driving scenario, one or more adjacent vehicles may be included.

The position amalgamation module described here is configured to amalgamate the position of the ego vehicle determined with the localization system and the position of the at least one adjacent vehicle determined with the 3D recognition module into a position amalgamation result.

According to step c), the position of the ego vehicle determined in step a) with the localization system is amalgamated with the position of the at least one adjacent vehicle determined with the 3D object recognition module in step b) into a position amalgamation result using the position amalgamation module. The position amalgamation result may comprise an amalgamated position. This amalgamated position may in turn be input into the localization system, based on which the position of the ego vehicle may be predicted for the next time step with improved accuracy. This amalgamated position may in particular be a position of the ego vehicle corrected by the determined position of the at least one adjacent vehicle.

In step c), the amalgamation may be performed using amalgamation algorithms. The amalgamation may include providing amalgamation coefficients, projecting the determined position of the at least one adjacent vehicle onto the ego vehicle, and determining the position amalgamation result.

The amalgamation coefficients may be the coefficients of uncertainty β for the position of the ego vehicle and for the position of each adjacent vehicle provided according to formulas (1), (2) and (3).

$${β}_{0} = \frac{1}{{σ}_{e g o}} \qquad ( 1 )$$

$${β}_{i} = \frac{1}{{a}_{1} {r}_{i} + {a}_{2} {σ}_{a d j , i}} , i = 1 , … , N \qquad ( 2 )$$

$$\vec{β} = {( {\sum }_{i = 0}^{N} {β}_{i} )}^{- 1} \vec{β} \qquad ( 3 )$$

Formula (1) shows that the coefficient of uncertainty for the position of the ego vehicle β₀ itself depends on the positioning accuracy of the ego vehicle σ_{ego}. The coefficient of uncertainty for the position of the ego vehicle β₀ is characterized here by a subscript zero.

Formula (2) shows that the coefficient of uncertainty for the position of an adjacent vehicle Bi depends on both the positioning accuracy of this adjacent vehicle σ_{adj}, and the distance between the ego vehicle and this adjacent vehicle rᵢ. Additionally, the positioning accuracy σ_{adj,i} can be weighted with a hyperparameter aᵢ and the distance rᵢ can be weighted with a further hyperparameter a₂. In this case, a₁ can be specified as 0.2 and a₂ as 0.8.

The coefficient of uncertainty for the position of an adjacent vehicle βᵢ is characterized here by a subscript natural number i=1, . . . , N. For example, i=1 means that only one adjacent vehicle is detectable in the vicinity of the ego vehicle. For i=2, it means that two adjacent vehicles are detectable in the vicinity of the ego vehicle so that one can be characterized by a subscript 1 and the other by a subscript 2.

All provided coefficients of uncertainty β are normalized to a unit vector according to formula (3).

The projection of the position of the at least one adjacent vehicle onto the ego vehicle may be performed according to formulas (4) and (5).

$${ψ}_{i} = a tan 2 ( {x}_{a d j , i} , {x}_{e g o} ) \qquad ( 4 )$$

$${x}_{ego}^{adj , i} = [ \begin{matrix}{x}_{adj , i}^{x} + {r}_{i} cos ( {ψ}_{i} ) \\ {x}_{adj , i}^{y} + {r}_{i} sin ( {ψ}_{i} )\end{matrix} ] \qquad ( 5 )$$

According to formula (4), the angle ψᵢ between the ego vehicle x_{ego} and an adjacent vehicle x_{adj,i} in the line of sight may be determined. The angle ψᵢ may be used to determine the position of this adjacent vehicle

$${x}_{e g o}^{a d j , i}$$

projected onto the ego vehicle along the line of sight according to formula (5). By way of the projection, the position of this adjacent vehicle can be provided to the ego vehicle.

For a plurality of adjacent vehicles, a coefficient of uncertainty βᵢ according to formulas (1), (2) and (3) and a projected position according

$${x}_{e g o}^{a d j , i}$$

to formulas (4) and (5) may be determined for each of the adjacent vehicles, such that said determined projected position is weighted with said determined coefficients of uncertainty and all such weighted projected positions are superposed onto a single projected position according to formula (6).

$${x}_{e g o}^{a d j} = {\sum }_{i = 1}^{N} {β}_{i} \cdot {x}_{e g o}^{a d j , i} \qquad ( 6 )$$

The position amalgamation result may be determined according to formula (7).

$${\tilde{x}}_{e g o} = {β}_{0} {x}_{e g o}^{G N S S} + {x}_{e g o}^{a d j} \qquad ( 7 )$$

Formula (7) shows that the position of the ego vehicle determined from the real-time measurement data (in particular the measured GNSS signals) is weighted with the coefficient of uncertainty β₀ determined according to Formula (1) and then

$${x}_{e g o}^{a d j}$$

superposed with the single projected position determined according to Formula (6) to obtain a position amalgamation result. The position amalgamation result may be input into the localization system so that the position of the ego vehicle for the next time step can be determined with the localization system with improved positioning accuracy, taking into account this position amalgamation result. The position amalgamation result according to formula (7) is a position of the ego vehicle corrected by the position of the at least one adjacent vehicle.

According to step d), the position of the ego vehicle for the next time step is determined with the localization system, taking into account the position amalgamation result. The position amalgamation result can in particular be determined according to formulas (1) to (7).

In step d), the position of the ego vehicle determined by a localization system based on the real-time measurement data in the current time step is not input into the localization system again, as is the case with known approaches, rather a position amalgamation result, e.g., in the form of a position of the ego vehicle corrected by the position of the at least one adjacent vehicle, such that the localization system determines the position of the ego vehicle for the next time step based on the position amalgamation result and based on real-time measurement data, such as the currently measured GNSS signals. The position of the at least one adjacent vehicle can be determined with the 3D object recognition module according to step b) and the position amalgamation result can be determined with the position amalgamation module according to step c).

The thus determined position of the ego vehicle has a higher positioning accuracy. A rigid body simulation and a broadband communication system, as mentioned above, are not required for this purpose. In particular, the method described here may be added as a redundancy to the conventional method of positioning with a conventional GNSS-based localization system. No costly hardware upgrades are necessary for this purpose. This relates primarily to software updates.

Since the localization system determines the position of the ego vehicle incrementally from real-time measurement data, steps a), b), c), and d) may be performed repeatedly if, while the ego vehicle is traveling, at least one adjacent vehicle may be detected in its vicinity. Although steps a) to d) are given here in a particular order, this order need not always be followed. For example, the individual steps can be repeated arbitrarily often independently of one another and/or can also partially be omitted during repetition. An at least partial overlap of the steps is possible.

It is preferred, in step a), that the position of the ego vehicle is determined with the localization system from measured GNSS signals.

It is also preferred, in step b), that the position of the at least one adjacent vehicle is predicted with the 3D object recognition module using the 3D bounding box prediction approach.

It is particularly preferred that the following substeps are carried out in step c):
i) providing amalgamation coefficients,
ii) projecting the position of the at least one adjacent vehicle onto the ego vehicle, and
iii) determining the position amalgamation result.

It is also preferred that, in sub-step ii), the position of the at least one adjacent vehicle is projected onto the ego vehicle along the line of sight of the ego vehicle.

Furthermore, a device for improved positioning for an ego vehicle is proposed. The device includes a localization system, a 3D object recognition module, and a position amalgamation module, wherein the localization system, the 3D object recognition module, and the position amalgamation module are installable in an ego vehicle. The localization system is configured to determine the position of an ego vehicle. The 3D object recognition module is configured to determine a position of at least one adjacent vehicle in the vicinity of the ego vehicle. The position amalgamation module is configured to determine a position amalgamation result by amalgamating the position of the ego vehicle with the position of the at least one adjacent vehicle. The localization system is capable of determining the position of the ego vehicle in consideration of the position amalgamation result.

It is preferred that the localization system is a GNSS-based localization system having a Kalman filter, wherein the Kalman filter is capable of determining the position of the ego vehicle based on the position amalgamation result and the measured GNSS signals.

It is also preferred that the 3D object recognition module is capable of predicting the position of the at least one adjacent vehicle using the 3D bounding box prediction approach.

It is additionally preferred that the 3D object recognition module is a deep learning trained neural network.

It is particularly preferred that the position amalgamation module comprises a first submodule for providing amalgamation coefficients, a second submodule for projecting the position of the at least one adjacent vehicle onto the ego vehicle, and a third submodule for determining a position amalgamation result.

It is particularly preferred that the first submodule, the second submodule, the third submodule and the Kalman filter are connected in series.

Furthermore, a control unit is proposed to carry out the described method.

In addition, a computer program is proposed to be used to carry out a method described here. In other words, this relates in particular to a computer program (product) comprising commands which, when the program is executed by a computer, prompt said computer to perform a method described here.

It is also proposed that a machine-readable storage medium is used, on which the computer program proposed here is stored. The machine-readable storage medium is typically a computer-readable data carrier.

### BRIEF DESCRIPTION OF THE DRAWINGS

The solution presented here and its technical environment are explained in more detail below, using the figures. It should be noted that the disclosure is not intended to be limited by the exemplary embodiments shown. In particular, unless explicitly stated otherwise, it is also possible to extract partial aspects of the facts explained in the figures and to combine them with other components and/or insights from other figures and/or the present description. The following figures provide a schematic diagram and example:

FIG. 1 shows a described method for a typical driving scenario; and

FIG. 2 shows a block diagram of a described method.

### DETAILED DESCRIPTION

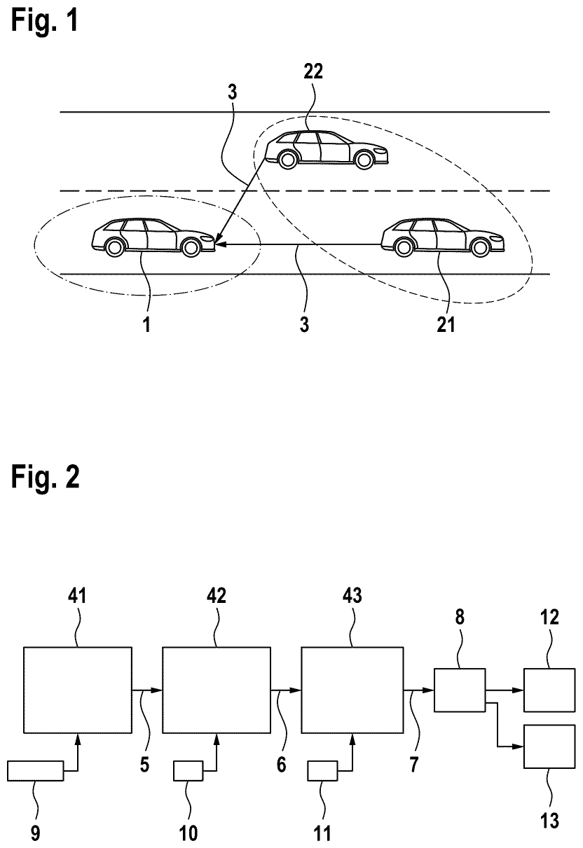

FIG. 1 shows a typical driving scenario: An ego vehicle 1 travels on a lane of a two-lane road, while an adjacent vehicle 21 in front of the ego vehicle 1 travels in the same lane and another vehicle 22 in front of the ego vehicle 1 travels in the other lane.

The position of the ego vehicle 1 may be determined according to step a) with a localization system installed in the ego vehicle 1. The localization system is typically a GNSS-based localization system.

The positions of the adjacent vehicles 21, 22 may be determined according to step b) with a 3D object recognition module installed in the ego vehicle 1. Therefore, no communication systems are required for the exchange of information between the ego vehicle 1 and the adjacent vehicles 21, 22.

In order to be able to provide the ego vehicle 1 with the positions of the adjacent vehicles 21, 22, the positions of the adjacent vehicles 21, 22 are projected onto the ego vehicle 1 along the line of sight 3 according to formulas (4) and (5). In addition, a coefficient of uncertainty for the position of the ego vehicle 1 according to formula (1) and a coefficient of uncertainty for the adjacent vehicle 21 as well as a coefficient of uncertainty for the additional adjacent vehicle 22 according to formulas (2) and (3) can be determined.

Thus, according to step c), the position of the ego vehicle 1 determined in step a) and the positions of the two adjacent vehicles 21, 22 determined in step b) can be amalgamated into a position amalgamation result according to formula (7) using a position amalgamation module installed in the ego vehicle. In this driving scenario, the position amalgamation result determined according to formula (7) is a position of the ego vehicle 1 corrected by the positions of the adjacent vehicles 21, 22.

According to step d), the position amalgamation result can in turn be input into the localization system so that the localization system can determine the position of the ego vehicle 1 for the next time step based on this position amalgamation result and the real-time measurement data.

The thus determined position of the ego vehicle has a higher positioning accuracy. A rigid body simulation and a broadband communication system, as mentioned above, are not required for this purpose. In particular, the method described here may be added as a redundancy to the conventional method of positioning with a conventional GNSS-based localization system. No costly hardware upgrades are necessary for this purpose. This relates primarily to software updates.

FIG. 2 schematically shows a block diagram of a described method.

In FIG. 2, a first submodule 41, a second submodule 42, a third submodule 43, and a Kalman filter 8 are connected in series. The Kalman filter 8 is in particular an extended Kalman filter and can be installed in a localization system. The first submodule 41, the second submodule and the third submodule 43 form a position amalgamation module upstream of the Kalman filter 8 so that the output value of the third submodule 43 can be supplied directly to the Kalman filter 8.

The first submodule 41 is configured to provide the amalgamation coefficients 5. The amalgamation coefficients 5 are in particular the coefficients of uncertainty according to formulas (1), (2) and (3). The first submodule 41 may be configured as software, into which the algorithms are loaded according to formulas (1), (2), and (3). Additionally, the distance rᵢ 9 between the ego vehicle and at least one adjacent vehicle may be entered into the first submodule 41, which may be determined, for example, using a 3D object recognition module. The provided amalgamation coefficients 5 may be input as input values into the second submodule 42.

The second submodule 42 is configured to provide the ego vehicle with the position of the at least one adjacent vehicle. The position of the at least one adjacent vehicle along the line of sight is projected onto the ego vehicle so that a projected position 6 is determined, which may be input as an input value into the third submodule 43. The second submodule 42 may also be configured as software, into which the algorithms are loaded according to formulas (4), (5), and (6). Additionally, status information 10 may be input into submodule 42. The status information 10 comprises in particular the position of the ego vehicle determined in step a) and the position of the at least one adjacent vehicle determined in step b).

The third submodule 43 is configured to provide the position amalgamation result 7 in the form of a position of the ego vehicle corrected by the position of the at least one adjacent vehicle, taking into account the amalgamation coefficient 5 provided in the submodule 41 and the projected position 6 provided in the submodule 42. The third submodule 43 may also be configured as software, into which the algorithms are loaded according to formula (7).

For this purpose, the position

$${x}_{e g o}^{G N S S}$$

11, which was determined from the real-time measurement data, such as measured GNSS signals, can be entered into the third submodule 43.

The Kalman filter 8, based on the position amalgamation result 7 in conjunction with the real-time measurement data, can thus predict the position of the ego vehicle for the next time step with increased accuracy and outputs an optimal ego vehicle position \hat{x}_{ego} 12 and a covariance \hat{P}_{ego} 13.

What is claimed is:

1. A method for improved positioning of an ego vehicle that includes a localization system, a 3D object recognition module, and a position amalgamation module, the method comprising:
a) determining the position of the ego vehicle for the current time step with the localization system;
b) determining a position of at least one adjacent vehicle in the vicinity of the ego vehicle with the 3D object recognition module;
c) amalgamating the position of the ego vehicle determined in step a) with the position of the at least one adjacent vehicle determined in step b) to form a position amalgamation result with the position amalgamation module; and
d) determining the position of the ego vehicle for the next time step with the localization system, taking into account the amalgamation result.

2. The method according to claim 1, wherein:
in step a), the position of the ego vehicle is determined with the localization system from measured GNSS signals.

3. The method according to claim 1, wherein:
in step b), the position of the at least one adjacent vehicle is predicted with the 3D object recognition module using the 3D bounding box prediction approach.

4. The method according to claim 1, wherein the following substeps are additionally carried out in step c):
i) providing amalgamation coefficients,
ii) projecting the position of the at least one adjacent vehicle onto the ego vehicle, and
iii) determining the position amalgamation result.

5. The method according to claim 4, wherein:
in substep ii), the position of the at least one adjacent vehicle is projected onto the ego vehicle along the line of sight of the ego vehicle.

6. A device for improved positioning for an ego vehicle, comprising a localization system, a 3D object recognition module, and a position amalgamation module, wherein the localization system, the 3D object recognition module, and the position amalgamation module are installable in an ego vehicle, and wherein
the localization system for determining the position of an ego vehicle,
the 3D object recognition module for determining a position of at least one adjacent vehicle in the vicinity of the ego vehicle, and
the position amalgamation module is configured to determine a position amalgamation result by amalgamating the position of the ego vehicle with the position of the at least one adjacent vehicle, and wherein
the localization system is capable of determining the position of the ego vehicle in consideration of the position amalgamation result.

7. The device according to claim 6, wherein the localization system is a GNSS-based localization system having a Kalman filter, and wherein the Kalman filter is configured to determine the position of the ego vehicle based on the position amalgamation result and the measured GNSS signals.

8. The device according to claim 6, wherein the 3D object recognition module is configured to predict the position of the at least one adjacent vehicle using the 3D bounding box prediction approach.

9. The device according to claim 6, wherein the 3D object recognition module comprises a deep learning trained neural network.

10. The device according to claim 6, wherein the position amalgamation module comprises a first submodule for providing amalgamation coefficients, a second submodule for projecting the position of the at least one adjacent vehicle onto the ego vehicle, and a third submodule for determining a position amalgamation result.

11. The device according to claim 10, wherein the first submodule, the second submodule, the third submodule, and the Kalman filter are connected in series.

12. A control unit, which is configured to carry out a method according to claim 1.

13. A computer program for carrying out a method according to claim 1.

14. A machine-readable storage medium on which the computer program according to claim 13 is stored.
